(19) United States
(12) Patent Application Publication
(10) Pub. No.: US 2012/0272280 A1
(43) Pub. Date: Oct. 25, 2012

(54) VIDEO PROCESSOR AND VIDEO PROCESSING METHOD

(75) Inventor: Hiroshi Kazawa, Kumagaya-shi (JP)

(73) Assignee: KABUSHIKI KAISHA TOSHIBA, Tokyo (JP)

(21) Appl. No.: 13/354,814

(22) Filed: Jan. 20, 2012

(30) Foreign Application Priority Data
Apr. 22, 2011 (JP) 2011-096468

(51) Int. Cl. H04N 7/173

(52) U.S. Cl. 725/109

(57) ABSTRACT

According to one embodiment, a video processor includes: a server function module configured to function as a server to provide data through a network; a renderer function module configured to function as a renderer to control displaying of data provided by another server in the network; a memory configured to store therein data that can be provided to the renderer function module; a receiver configured to receive, from an external device, identification information used to identify a server providing corresponding data; a determination module configured to determine whether the server identified by using the identification information is the server of the video processor; and a display controller configured to control displaying of the data stored in the memory if it is determined that the server identified by using the identification information is the server of the video processor.

### CROSS-REFERENCE TO RELATED APPLICATIONS

This application is based upon and claims the benefit of priority from Japanese Patent Application No. 2011-096468, filed Apr. 22, 2011, the entire contents of which are incorporated herein by reference.

### FIELD

An embodiment described herein relates generally to a video processor and a video processing method.

### BACKGROUND

Nowadays, electronic devices conforming to the universal plug and play (UPnP, which is a registered trademark) audio video (AV) standard and the digital living network alliance (DLNA) guideline have been used. The UPnP AV standard is a protocol as an upper layer of the UPnP protocol allowing electronic devices to join a network by only connecting them with each other, and aims to reproduce audio-video (AV) content. The DLNA guideline is an industry standard allowing electronic devices to have compatibility with each other, and a home network among the electronic devices to be achieved. The DLNA guideline adopts the UPnP protocol as a procedure of communications among the electronic devices.

In the UPnP standard, a device and a control point which controls the device are defined. In the UPnP AV standard, a media server (UPnP AV media server) storing therein content, and a media renderer (UPnP AV media renderer) reproducing content are defined as the devices. The control point (UPnP AV control point) finds a device on the network to control the device. In the UPnP AV standard, the media renderer selected by the control point acquires, through the network, content in the media server selected by the control point to reproduce the content.

Under the protocols such as the UPnP AV standard, even when a device comprises a media server function for storing content designated by a control terminal such as the control point, and a media renderer function in the same device, processing relating to both functions is performed through a network interface in the same manner as it is performed when the functions are comprised in different devices.

In this way, when both media server and media renderer functions are comprised in the same device, unnecessary processing is required, and processing burden is increased.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a structure of a network system according to an embodiment, in which a plurality of electronic devices are connected each other through a network;

FIG. 2 is an exemplary block diagram of a functional structure of a smartphone in the embodiment;

FIG. 3 is an exemplary block diagram of a hardware structure of a television receiver in the embodiment;

FIG. 4 is an exemplary block diagram of a software structure of the television receiver in the embodiment;

FIG. 5 is an exemplary schematic diagram illustrating title information accepted to be registered as a reproduction target in the embodiment;

FIG. 6 is an exemplary sequence diagram of processing to reproduce content stored in a recorder in the network system in the embodiment;

FIG. 7 is an exemplary sequence diagram of processing to reproduce content stored in the television receiver in the network system in the embodiment; and

FIG. 8 is an exemplary flowchart of processing to reproduce content by a media renderer function module of the television receiver in the embodiment.

### DETAILED DESCRIPTION

In general, according to one embodiment, a video processor comprises: a server function module, a renderer function module, a memory, a receiver, a determination module, and a display controller. The server function module is configured to function as a server to provide data through a network. The renderer function module is configured to function as a renderer to control displaying of data provided by another server in the network. The memory is configured to store therein data that can be provided to the renderer function module. The receiver is configured to receive, from an external device, identification information used to identify a server providing corresponding data. The determination module is configured to determine whether the server identified by using the identification information is the server of the video processor. The display controller is configured to control displaying of the data stored in the memory if it is determined that the server identified by using the identification information is the server of the video processor.

An embodiment is described below in which a video processor is applied to a television receiver. In the embodiment, devices conforming to the universal plug and play (UPnP, which is the registered trademark) audio visual (AV) standard and the digital living network alliance (DLNA) guide line are used. However, applicable devices are not limited to those described in the embodiment. For example, the feature structure of the embodiment described below may be applied to devices or systems conforming to standards that are equivalent to or compatible with the above-described standard and the guide line, and also applied to devices and systems conforming to other standards and guidelines.

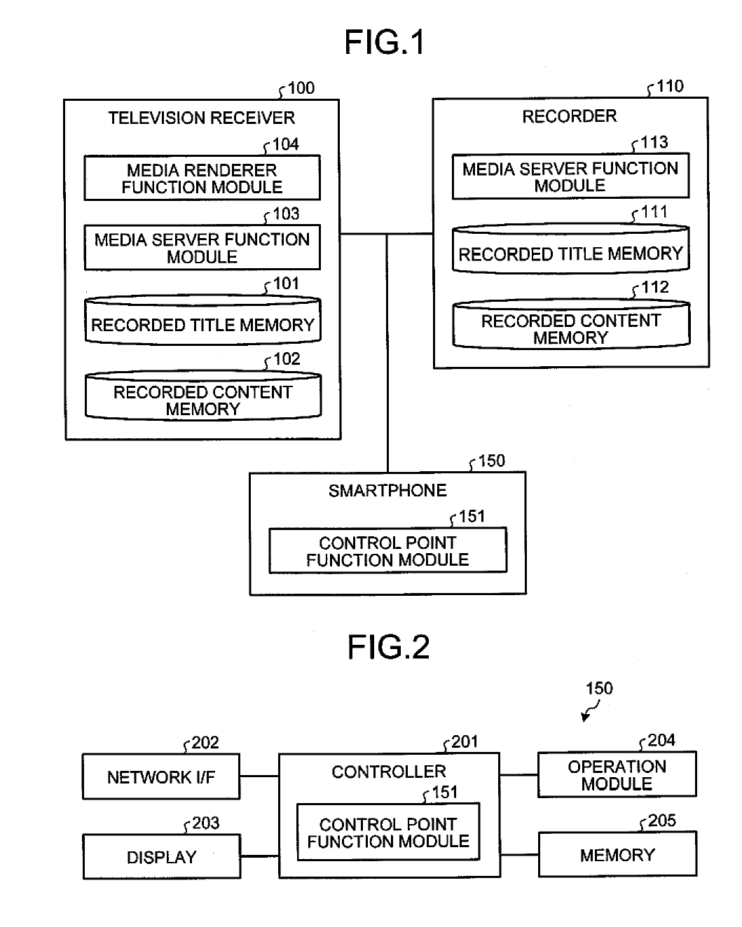

FIG. 1 is a block diagram of a structure of a network system according to the embodiment. In the network system, a plurality of electronic devices are connected each other through a network. The electronic devices connected each other in the network system are compliant with the UPnP AV standard and the DLNA guide line.

In the network system illustrated in FIG. 1, a television receiver 100, a recorder 110 that can record and reproduce content by using digital versatile discs (DVDs) and Blue-ray (registered trademark) disks, and a smartphone 150 serving as a control point are connected each other as UPnP standard-compliant devices through a net work such as a local area network (LAN). The network may be a wired network, a wireless network, or a mixed network of the wired and wireless networks. The number and types of devices connected with the network are not limited to those in the example of FIG. 1. Any UPnP AV-compliant device can be connected with the network.

The television receivers are available that have built-in or optional external HDDs for recording programs and watching recorded titles. Devices are also available that have functions to provide recorded titles on a home network, and to enable recorded videos to be reproduced on other devises through the network. Furthermore, other devices are available that have functions to receive reproduction instructions from electronic devices having reproduction instruction functions (control point functions), such as the smartphones, and to reproduce content provided by the above-described devices.

A function that stores content, provides title information of the content to other electronic devices, and supplies designated content according to a request from a media renderer is called as a media server (UPnP AV media server) function. A function of the media renderer that receives designated content from the media server according to a request from another electronic device and reproduces the content is called as a media render (UPnP AV media renderer) function.

In relation to the functions, the following system is called as a three-BOX reproduction system. An electronic device having the control point function (hereinafter referred to as a control point), a device having the media server function, and a device having the media renderer function are connected each other over a network. The control point acquires a title list of content provided by the media server function, and instructs the device having the media renderer function to reproduce the content of the title designated by the control point.

The smartphone 150 executes an installed controller program to realize a control point function module 151 that detects a device providing services in accordance with the UPnP standard and operates the device so that the control point function module 151 functions as the “UPnP AV control point”. A user can, for example, operate the UPnP standard-compliant devices (in the embodiment, the television receiver 100 and the recorder 110) by using the smartphone 150 having the control point function module 151, and reproduce content provided by the devices.

In FIG. 1, each of the television receiver 100 and the recorder 110 has the media server function in the three-BOX reproduction system. In addition, the television receiver 100 has the media renderer function in the three-BOX reproduction system.

The television receiver 100 according to the embodiment comprises a recorded title memory 101, a recorded content memory 102, a media server function module 103, and a media renderer function module 104. The television receiver 100 thus structured can provide content stored in the recorded content memory 102 and content title information stored in the recorded title memory 101 to other electronic devices by using the media server function module 103, and can also display and reproduce content provided by other electronic devices (e.g., the recorder 110) by using the media renderer function module 104.

The recorder 110 comprises a recorded title memory 111, a recorded content memory 112, and a media server function module 113. The recorder 110 thus structured can provide content stored in the recorded content memory 112 and content title information stored in the recorded title memory 111 to other electronic devices (e.g., the television receiver 100) by using the media server function module 113.

FIG. 2 is a block diagram of a functional structure of the smartphone 150. As illustrated in FIG. 2, the smartphone 150 comprises a controller 201, a network interface (I/F) 202, a display 203, an operation module 204, and a memory 205.

The controller 201 comprises a micro controller, a central processing unit (CPU), a random access memory (RAM), and a read only memory (ROM), and centrally controls the operation of the smartphone 150. For example, the CPU loads various programs stored in the ROM into a working area of the RAM, sequentially executes the programs, and outputs control signals to each module inside the smartphone 150 to control operation of each module.

The network I/F 202 functions as an interface for communications through the network under the control of the controller 201. Specifically, the network I/F 202 communicates, in accordance with the UPnP AV standard, with the devices such as the television receiver 100 and the recorder 110 connected with the smartphone 150 through the network.

The display 203 is a liquid crystal display (LCD) , for example, and displays an operation screen, an error display screen, and the like under the control of the controller 201. The smartphone 150 notifies a user of a processing result with the screen displayed by the display 203. The notification to the user may be done with voices output from a speaker (not illustrated), for example, under the control of the controller 201.

The operation module 204 may be operation keys or a touch panel for receiving operation instructions from a user. The received operation instructions are notified to the controller 201. The memory 205 may be the RAM or a rewritable non volatile memory.

The controller 201 executes a control program stored in the ROM to realize the control point function module 151. The control point function module 151 controls communications performed by the network I/F 202 through the network in accordance with the UPnP AV standard. Specifically, the control point function module 151 controls searching devices connected with the network, acquiring desired information such as content information from the searched device, and communications relating to desired operation on the searched device. The information acquired from each device is stored in the memory 205 under the control of the control point function module 151.

In the embodiment, the smartphone 150 is used as the control point. The control point, however, is not limited to the smartphone. Any electronic device maybe used as the control point besides the smartphone.

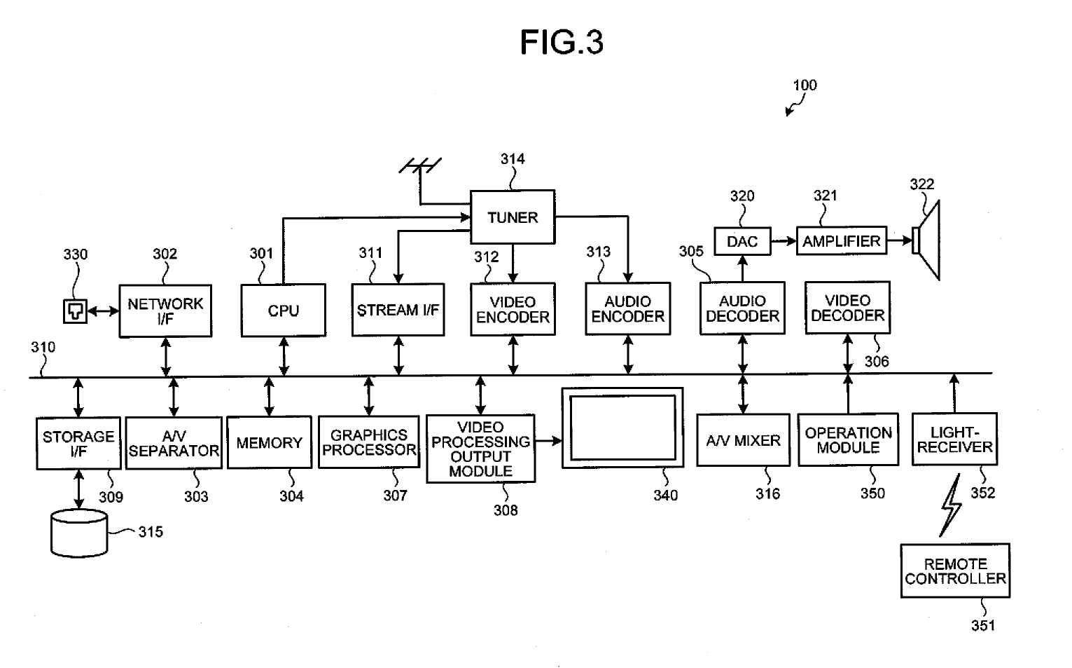

The television receiver 100 is described below. FIG. 3 is a block diagram of a hardware structure of the television receiver 100. The television receiver 100 illustrated in FIG. 3 comprises a CPU 301, a network interface (I/F) 302, an audio-video (A/V) separator 303, a memory 304, an audio decoder 305, a video decoder 306, a graphics processor 307, a video processing output module 308, a storage interface (I/F) 309, a bus 310, a stream interface (I/F) 311, a video encoder 312, an audio encoder 313, a tuner 314, a hard disk drive (HDD) 315, an audio-video (A/V) mixer 316, a digital-to-analog converter (DAC) 320, an amplifier 321, a speaker 322, a terminal 330, a display panel 340, an operation module 350, a remote controller 351, and a light-receiver 352.

An analog video signal received by the tuner 314 is encoded by the video encoder 312. An analog audio signal received by the tuner 314 is encoded by the audio encoder 313. The encoded video signal and audio signal are mixed by the A/V mixer 316 to form stream. On the other hand, a digital video signal received by the tuner 314 is input to the stream I/F 311 as stream of the moving picture experts group 2 (MPEG2)-transport stream (TS) format, for example. The stream is recorded in the HDD 315 through the storage I/F 309. The HDD 315 stores therein the recorded title memory 101 and the recorded content memory 102 illustrated in FIG. 1.

The terminal 330 is the Ethernet (registered trademark) terminal to connect with a network NT, for example. Information received from another device having a content transmission function connected with the network NT is transmitted through the terminal 330 and the network I/F 302 to be received by the television receiver 100.

The stream recorded in the HDD 315, and data of content that is received from another device having the content transmission function through the terminal 330 and the network I/F 302, and temporarily stored in the memory 304 are separated into video data and audio data by the A/V separator 303 under the control of the CPU 301. The video data after separation is decoded by the video decoder 306. The decoded video data is output from the video processing output module 308 as a video signal, and displayed on the display panel 340. The audio data after separation by the A/V separator 303 is decoded by the audio decoder 305, processed by the DAC 320 and the amplifier 321, and output from the speaker 322.

The CPU 301 executes various programs stored in a storage medium such as the ROM (not illustrated) and the HDD 315 to overall control the operation of the television receiver 100. Specifically, the CPU 301 produces a graphical user interface (GUI) display screen, for example, in cooperation with the graphics processor 307, stores the GUI display screen in the memory 304 such as the RAM, and reads and displays the screen on the display panel 340 as needed. When receiving operation performed with respect to the television receiver 100 by using the remote controller 351, for example, through the operation module 350 and the light-receiver 352, the CPU 301 selects one of broadcast signals (channels) received by the tuner 314 according to the operation, or detects input on the GUI display screen.

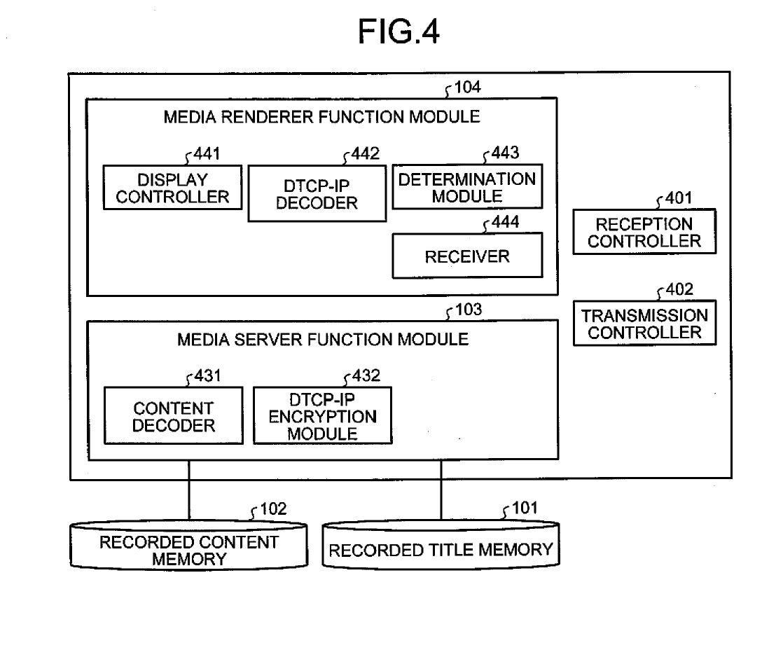

The functional structure of the television receiver 100 is described below. FIG. 4 is a block diagram of a software structure realized in the television receiver 100 as a result of executing a video processing program. The video processing program can be applied to any device having the media renderer function and the media server function.

As illustrated in FIG. 4, the television receiver 100 executes the video processing program to realize the media renderer function module 104, the media server function module 103, a reception controller 401, and a transmission controller 402. The modules and controllers thus realized in the television receiver 100 perform various processing by using information recorded in the recorded title memory 101 and the recorded content memory 102.

In a conventional device having both a media renderer function and a media server function in the same device, internal transfer is not performed, but processing in accordance with the DLNA guideline is performed in the same manner as typical or normal network transfer. Specifically, in the same manner as a typical or normal media server, content is encrypted in accordance with a digital transmission content protection over Internet protocol (DTCP-IP). Then, control for transferring the content is performed. Thereafter, decoding in accordance with the DTCP-IP is performed on the encrypted content in the same manner as a typical or normal media renderer. Then, the content is reproduced. However, such control performed in the same device causes a burden due to unnecessary processing such as encryption and decoding. The television receiver 100 according to the embodiment can reduce such burden with the following structure.

The recorded content memory 102 encrypts content (program) recorded by the television receiver 100 and stores therein the encrypted content. The content stored in the recorded content memory 102 can be provided to an electronic device having the media renderer function.

The recorded title memory 101 stores therein title information of the content stored in the recorded content memory 102. The title information stored in the recorded title memory 101 can be provided to an electronic device having the media renderer function or the control point function. The title information is provided with an extensible markup language (XML) format in the embodiment. The title information, however, may be provided with other format.

The reception controller 401 controls the network I/F 302 to receive information from electronic devices connected through the network.

The transmission controller 402 controls the network I/F 302 to transmit information to electronic devices connected through the network.

The media renderer function module 104 comprises a display controller 441, a DTCP-IP decoder 442, a determination module 443, and a receiver 444. When receiving a request to reproduce content from an external electronic device, the media renderer function module 104 controls reproduction of content stored in the television receiver 100 or the recorder 110.

The receiver 444 receives, from an external device having the control point function (e.g., the smartphone 150), a request to display content (data) and an Internet protocol (IP) address indicating a providing destination of the content.

In the three-BOX reproduction system, the television receiver 100 starts processing to reproduce content when the receiver 444 of the television receiver 100 having the media renderer function receives a registration request of title information of content to be reproduced, and an instruction to reproduce (display request) the content indicated by the registered title information from an external device having the control point function. In the embodiment, the title information accepted by the receiver 444 to be registered includes an IP address indicating the providing destination of the content. The title information accepted to be registered is temporarily stored in the RAM (not illustrated), for example.

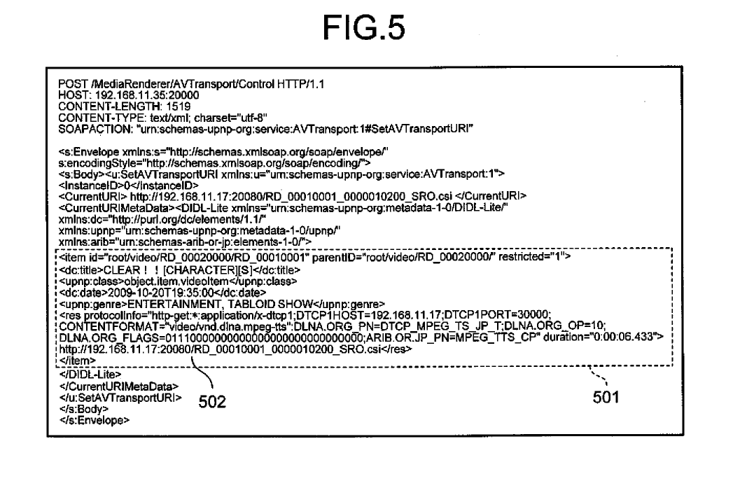

FIG. 5 is a diagram illustrating title information received to be registered as a reproduction target. As illustrated in FIG. 5, various information used to register content to be reproduced in accordance with the DLNA guide line is stored. The information in a region 501 relates to reproduced content and includes a name and attribute information of the content. In addition, a uniform resource locator (URL) 502 is included in which the content is stored.

The IP address (http://192.168.11.17) included in the URL 502

(http://192.168.11.17:20080/RD_{—}00010001_{—}0000010200_SRO.csi) is the providing destination of the content. A device having the media renderer function can acquire content stored in the URL 502 from the providing destination indicated with the IP address by sending a hyper text transfer protocol (HTTP)-GET request.

The determination module 443 determines whether the media server identified by the IP address included in the title information accepted by the receiver 444 to be registered is in the own device (the television receiver 100). In the embodiment, identification information used to identify content and the media server providing the content is the IP address. The identification information, however, may be other identification information (e.g., a media access control (MAC) address).

If the determination module 443 determines that the media server identified by the IP address is in the own device (the television receiver 100), the media renderer function module 104 requests the media server function module 103 to acquire the content indicated with the IP address. In response to the request, the media server function module 103 reads the content from the recorded content memory 102, and transfers the content to the media renderer function module 104 without encrypting the content, i.e., without performing encryption on the content in accordance with the DTCP-IP. When content needs to be transferred in the same device as described above, encryption in accordance with the DLNA guideline is performed in the conventional device. The television receiver 100 according to the embodiment, however, does not need to perform encryption on the content.

The display controller 441 controls reproduction (displaying) of the received content on the display panel 340.

If the determination module 443 determines that the media server identified by the IP address is not in the own device (the television receiver 100), the transmission controller 402 of the media renderer function module 104 controls the transmission of a request to acquire content to another device identified by the IP address. The reception controller 401 controls receiving of the content which has been encrypted in accordance with the DTCP-IP corresponding to the acquisition request from the device.

The DTCP-IP decoder 442 decodes, in accordance with the DTCP-IP, the content of which the reception controller 401 controlled the receiving.

The display controller 441 controls reproduction (displaying) of the decoded content on the display panel 340.

The media server function module 103 comprises a content decoder 431 and a DTCP-IP encryption module 432.

When receiving a request to acquire title information from an external electronic device having the control point function or the media renderer function, the media server function module 103 transmits title information stored in the recorded title memory 101 to the external electronic device by using the transmission controller 402.

When receiving a request to acquire content from an electronic device having the media renderer function, the media server function module 103 transmits the content stored in the recorded content memory 102 to the electronic device by using the transmission controller 402. Prior to the transmission, the media server function module 103 encrypts the content in accordance with the DTCP-IP.

The content decoder 431 reads the content to be provided to an external device or the media renderer function module 104 from the recorded content memory 102, and decodes the content. When transferring the content to the media renderer function module 104, the media server function module 103 transfers the decoded content to the media renderer function module 104. On the other hand, when the content is transmitted to an external device, the content needs to be encrypted. The encryption is performed by the DTCP-IP encryption module 432.

When the content is transmitted to an external device, the DTCP-IP encryption module 432 encrypts, in accordance with the DTCP-IP, the decoded content. Thereafter, the transmission controller 402 controls transmission of the encrypted content to the external device.

The television receiver 100 according to the embodiment comprises both the media renderer function module 104 and the media server function module 103, and switches between reproduction though the network and local reproduction depending on whether content instructed by the smartphone 150 to be reproduced is provided by the own device.

As illustrated in FIG. 1, the recorder 110 comprises the media server function module 113, the recorded title memory 111, and the recorded content memory 112. The recorded title memory 111 has the same structure as the recorded title memory 101 of the television receiver 100. The recorded content memory 112 has the same structure as the recorded content memory 102 of the television receiver 100. The media server function module 113 has the same structure, and functions as the same manner as the media server function module 103 of the television receiver 100. Therefore, description thereof is omitted. In other words, the recorder 110 functions as a media server.

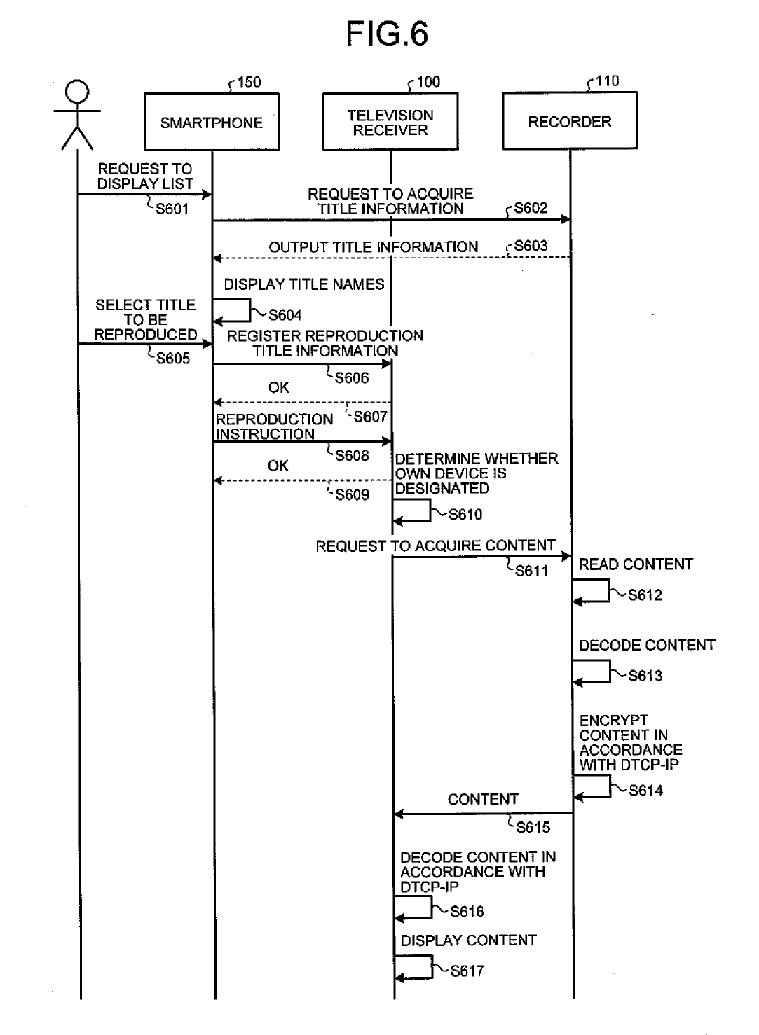

Processing to reproduce content stored in the recorder 110 in the network system according to the embodiment is described below. FIG. 6 is a sequence diagram of the processing in the network system according to the embodiment.

While using the smartphone 150, a user selects a device storing therein content (the recorder 110 in the example of FIG. 6) and performs operation of a request to display a list of content (S601). Thereafter, the smartphone 150 transmits a request to acquire title information recorded in the recorded title memory 111 to the recorder 110 (S602). The recorder 110 reads the title information from the recorded title memory 111, and transmits the title information to the smartphone 150 (S603). The title information to be transmitted includes all of the title information of content that can be reproduced by the recorder 110.

The smartphone 150 displays, on the display 203, the list of title names, for example, from the received title information (S604). Accordingly, the user can know reproducible content.

Then, the smartphone 150 receives, from the user, a selected title to be reproduced (S605). Upon receiving the selection, the smartphone 150 transmits the title information indicating a reproduction target to the television receiver 100, and requests the television receiver 100 to register the title information (e.g., illustrated in FIG. 5) (S606). Upon receiving the request, the media renderer function module 104 of the television receiver 100 registers the title information. Then, the television receiver 100 transmits that the request has been accepted (OK) to the smartphone 150 (S607).

The smartphone 150 transmits an instruction to reproduce the content identified by the registered title information to the television receiver 100 (S608). Then, the television receiver 100 transmits that the request has been accepted (OK) to the smartphone 150 (S609).

Thereafter, the determination module 443 of the television receiver 100 determines whether the IP address included in the title information indicates the own device (S610). In the example of FIG. 6, it is determined that the IP address does not indicate the own device.

In this case, the transmission controller 402 of the television receiver 100 transmits a request to acquire (HTTP-GET) the content identified by the title information to the device (the recorder 110) identified by the IP address included in the title information (S611).

Upon receiving the request, the recorder 110 reads the content requested to be acquired from the recorded content memory 112 (S612). The recorder 110 decodes the read content because the read content has been encrypted (S613).

Then, the recorder 110 encrypts the content in accordance with the DTCP-IP in order to transmit the content to the television receiver 100 (S614). Thereafter, the recorder 110 transmits the content to the television receiver 100 (S615).

The reception controller 401 of the television receiver 100 receives the content, and thereafter, the DTCP-IP decoder 442 of the media renderer function module 104 decodes the content in accordance with the DTCP-IP (S616).

Then, the display controller 441 controls displaying of the decoded content on the display panel 340 (S617).

Through the above-described sequence, content stored in the recorder 110 can be displayed on the television receiver 100.

In conventional technique, when a device includes both the media renderer function and the media server function, almost the same processing as the sequence illustrated in FIG. 6 (except for S610) is performed in the device. In this case, although the encryption is unnecessary because the content is not transmitted and received through the network, the encryption is performed.

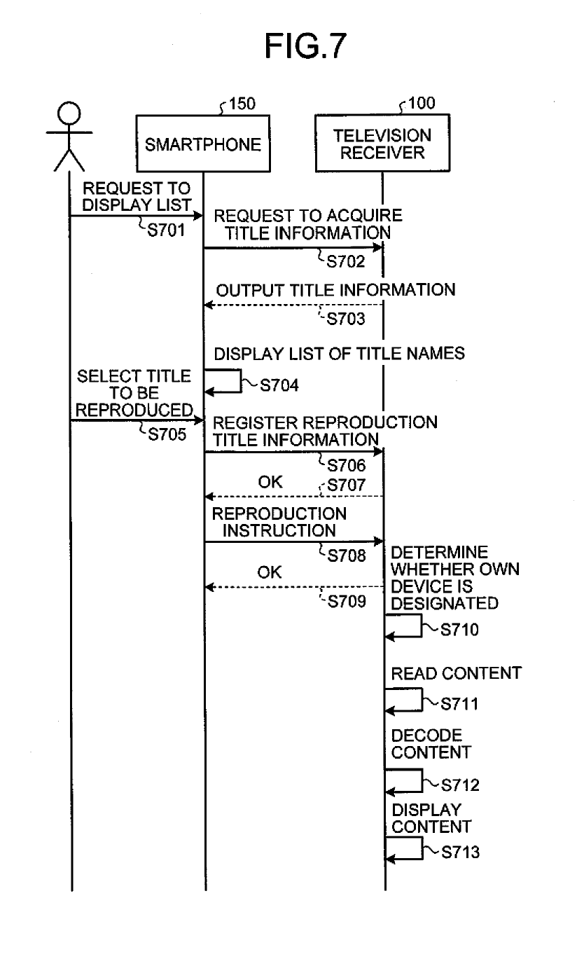

Processing to reproduce content stored in the television receiver 100 in the network system according to the embodiment is described below. FIG. 7 is a sequence diagram of the processing in the network system according to the embodiment.

While using the smartphone 150, a user selects a device storing therein content (the television receiver 100 in the example of FIG. 7) and performs operation of a request to display a list of content (S701). The operation is performed in the same manner as S601 of FIG. 6 except for that the selected device differs from that in S601. In other words, the user can select content by performing the same operation regardless of whether the content to be reproduced is stored in the television receiver 100 or in the recorder 110.

The smartphone 150 transmits a request to acquire title information to the television receiver 100, and the television receiver 100 transmits the title information corresponding to the acquisition request to the smartphone 150 (S702 to S703). The smartphone 150 displays, on the display 203, the list of title names, for example, from the received title information (S704). The processing procedure from S702 to S704 is performed in the same manner as S601 to S604 of FIG. 6 except for that the communication destination of the smartphone 150 is changed from the recorder 110 to the television receiver 100. In other words, the same processing is performed on the recorder 110 and the television receiver 100 as the device having the renderer function.

In the same manner as S605 to S609 of FIG. 6, the smartphone 150 instructs the television receiver 100 to reproduce the content (S705 to S709).

Thereafter, the determination module 443 of the television receiver 100 determines whether the IP address included in the title information indicates the own device (S710). In the example of FIG. 7, it is determined that the IP address indicates the own device.

In this case, the media renderer function module 104 of the television receiver 100 requests the media server function module 103 to acquire the content instructed to be reproduced. Upon receiving the request, the content decoder 431 of the media server function module 103 reads the content instructed to be reproduced from the recorded content memory 102 (S711). The content decoder 431 decodes the read content because the read content has been encrypted (S712). Then, the media server function module 103 transfers the content to the media renderer function module 104.

Then, the display controller 441 controls displaying of the decoded content on the display panel 340 (S713).

In this way, content of the television receiver 100 is reproduced by the operation of the smartphone 150 in the same manner as the content in the recorder 110 is reproduced. As a result, the user can select desired content without being aware of whether the content is stored in which device when selecting the content.

In the television receiver 100 according to the embodiment, encryption is not required when content managed by the media server function module 103 is reproduced by the media renderer function module 104 in the same device. As a result, processing burden can be reduced.

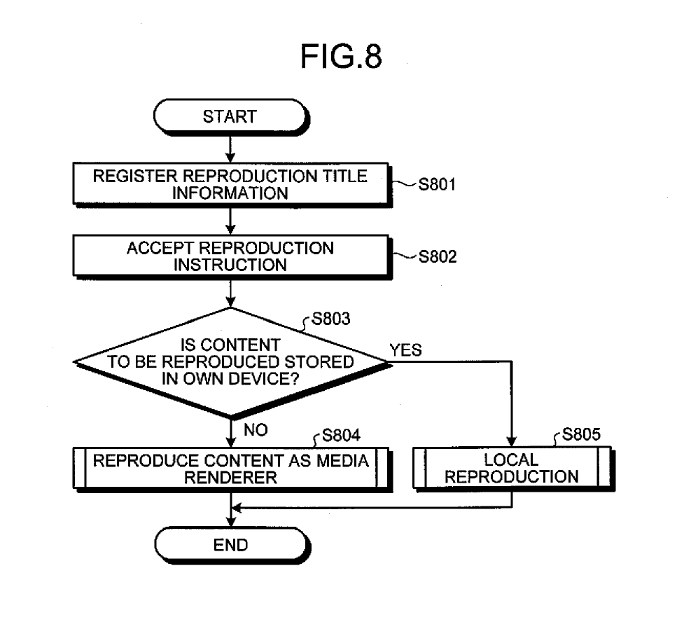

Processing to reproduce content performed by the media renderer function module 104 of the television receiver 100 according to the embodiment is described below. FIG. 8 is a flowchart of the processing in the media renderer function module 104 according to the embodiment. Prior to the processing illustrated in FIG. 8, a display of title names, for example, has been performed based on title information.

In the television receiver 100, the receiver 444 receives title information indicating content to be reproduced from the smartphone 150 through the reception controller 401, and temporarily registers the title information in the RAM (not illustrated) as the reproduction target (S801).

Then the receiver 444 receives a request to reproduce the content from the smartphone 150 through the reception controller 401 (S802).

Then, the determination module 443 extracts, with reference to the registered title information, the IP address that is included in the title information, and indicates the device in which the content is stored. The determination module 443 determines whether the content to be reproduced is stored in the own device based on the extracted IP address (S803). If it is determined that the content is not stored in the own device (NO at S803), the media renderer function module 104 functions as the conventional media renderer in the three-BOX reproduction system to reproduce the content stored in the recorder 110, for example (S804).

On the other hand, if it is determined that the content is stored in the own device (YES at S803), the content stored in the recorded content memory 102 is decoded and the decoded content is subjected to the local reproduction in the television receiver 100 without using the media server function and the media renderer function in the same device 100 in the conventional manner (S805).

As described above, the television receiver 100 according to the embodiment performs different processing based on whether content to be reproduced is stored in the recorded content memory 102 of the television receiver 100. When content stored in the recorded content memory 102 is reproduced, the television receiver 100 performs the local reproduction without using the DTCP-IP. As a result, processing burden can be reduced.

The television receiver 100 according to the embodiment, when content to be reproduced is stored therein, can reproduce the content by performing the local reproduction instead of the reproduction through the network, without using the media server function and the media renderer function. As a result, processing burden can be reduced.

The video processing program executed by the television receiver 100 of the embodiment is recorded into a computer readable storage medium with a format installable in or a file executable by a computer, and provided. The examples of the storage medium comprise compact disk ROMs (CD-ROMs), flexible disks (FDs), CD-recordables (CD-Rs), and digital versatile disks (DVDs).

The video processing program executed by the television receiver 100 of the embodiment may be stored in a computer connected to a network such as the Internet, and be provided by being downloaded through the network. The video processing program executed by the television receiver 100 of the embodiment may be provided or delivered through a network such as the Internet.

The video processing program of the embodiment maybe provided by being preliminarily stored in the ROM, for example.

The video processing program executed by the television receiver 100 of the embodiment has a module structure comprising the above-described modules and controllers (the transmission controller, the reception controller, the media renderer function module, and the media server function module). In actual hardware, the CPU 301 reads the video processing program from the memory 304 and executes the video processing program. Once the program is executed, the above-described modules and controllers are loaded on a main storage, so that the transmission controller, the reception controller, the media renderer function module, and the media server function module are formed in the main storage.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video processor comprising:
a server function module configured to provide data through a network;
a renderer function module configured to control displaying of data provided by a first server in the network;
a memory configured to store therein data accessible by the renderer function module;
a receiver configured to receive, from an external device, identification information identifying a server providing corresponding data;
a determination module configured to determine whether the server identified by the identification information is the server of the video processor; and
a display controller configured to control displaying of the data stored in the memory when the server identified by the identification information is the server of the video processor.

2. The video processor of claim 1, further comprising:
a transmitter configured to transmit, when the determination module determines that the server identified by the identification information is not the server of the video processor, a request to acquire the data to a second server identified by the identification information; and
a receiver configured to receive the data from the first server, wherein
the display controller is configured to control displaying of the data received from the second server.

3. The video processor of claim 1, wherein the receiver is configured to receive an internet protocol (IP) address as the identification information.

4. The video processor of claim 1, further comprising a display configured to display the data under a control of the display controller.

5. The video processor of claim 1, wherein
the server function module is configured to function as a media server which is compliant with a technical specification of the universal plug and play (UPnP),
the renderer function module is configured to function as a media renderer which is compliant with the technical specification of the UPnP, and
the memory is configured to store therein the data which is encrypted,
the video processor further comprising a decoder configured to decode the data before the display controller controls displaying of the data.

6. A video processing method performed in a video processor, the video processing method comprising:
first functioning, by a server function module, as a server to provide data through a network;
second functioning, by a renderer function module, as a renderer to control displaying of data provided by a first server in the network;
storing, by a memory, therein data that can be provided to the renderer function module;
receiving, by a receiver, from an external device, identification information identifying a server providing corresponding data;
determining, by a determination module, whether the server identified by using the identification information is the server of the video processor; and
controlling, by a display controller, displaying of the data stored in the memory when it is determined that the server identified by using the identification information is the server of the video processor.
